(19) United States
(12) Patent Application Publication
(10) Pub. No.: US 2006/0031620 A1
(43) Pub. Date: Feb. 9, 2006

(54) Memory controller with a plurality of parallel transfer blocks

(76) Inventors: Andreas Jakobs, Munchen (DE); Peter Gregorius, Munchen (DE)

Correspondence Address: PATTERSON & SHERIDAN, LLP;Gero McClellan / Infineon Technologies, 3040 POST OAK BLVD.,, SUITE 1500, HOUSTON, TX, 77056, US

(21) Appl. No.: 11/174,950

(22) Filed: Jul. 5, 2005

(30) Foreign Application Priority Data
Jul. 3, 2004 (DE) 10 2004 032 402.6

(51) Int. Cl. G06F 13/14

(52) U.S. Cl. 710/305

(57) ABSTRACT

The invention relates to a memory controller for the exchange of data between a digital memory arrangement (RAMs) and a data processing device, comprising a distributor circuit, to be connected to the data processing device, and a plurality m≧2 of parallel transfer blocks, each of which is constructed for transmitting data words which in each case consist of n parallel data bits. According to the invention, in at least one group of p≧2 transfer blocks, only one of the transfer blocks is configured as a master for the transfer of strobe signals by this transfer block. All other transfer blocks of the group are in each case configured as a slave in that the strobe terminals with this transfer block provided for transmitting the strobe signal to the distributor circuit are connected to the strobe terminals of the master which are provided for transmitting the strobe signal to the distributor circuit.

### CROSS-REFERENCE TO RELATED APPLICATIONS

This application claims foreign priority benefits under 35 U.S.C. §119 to co-pending German patent application number DE 10 2004 032 402.6, filed 3 Jul. 2004. This related patent application is herein incorporated by reference in its entirety.

### BACKGROUND OF THE INVENTION

1. Field of the Invention

The invention relates to a memory controller for the exchange of data between a digital memory arrangement and a data processing device.

2. Description of the Related Art

Digital random access memories, generally known by the acronym RAM, are usually produced as integrated packages on semiconductor chips. Such RAM packages contain a multiplicity of memory cells which are selectively addressable in order to optionally read out or write in memory data on these. In order to establish the required communication with other circuits, a RAM package has a number of groups of external terminals. Apart from the data terminals via which the memory data are input and output, these external terminals include a plurality of control terminals. The latter comprise, among others, address terminals for receiving the information for addressing the memory cells and command terminals for receiving commands for initiating the various operations of the RAM package. Added to these are clock and timing control terminals for synchronizing the communication.

The number of data terminals used on a RAM package depends on the number of data bits which are in each case input or output at the package in parallel form per cycle of the data rate. This number, called “word width” in the text which follows, is one of the specification parameters of the RAM package; word widths of 4, 8 and 16 are commonly used at present. In the case of memories to be operated quickly (high data rates) in particular, it is required to additionally allocate to the bidirectional data terminals a bidirectional “strobe” terminal in order to be able to receive or transmit simultaneously with the data words an accompanying data strobe signal, the edges of which form the timing reference for sampling the data. Furthermore, it may be desirable to allocate to the bidirectional data terminals a (unidirectional) terminal for receiving a masking signal in order to be able to mask selected received data words out of an incoming burst of data words, so that the relevant data bits remain unaffected, that is to say, leave unchanged the content of the memory cells addressed with this word at the same time.

In operation, the exchange of data between a RAM and the associated partner (e.g., a data processing device such as, for example, a computing unit) takes place over a controlling circuit, the so-called memory “controller”. This controller transmits and receives the memory data together with the strobe signal at corresponding bidirectional data terminals on the side facing the RAM. Furthermore, it generates and transmits the abovementioned control signals for the RAM (among others, the command and address signals and the clock signal) and, if necessary, also the masking signal for the transmitted data words at corresponding unidirectional output terminals on this side. On the other side, which faces the partner (data processing device), there are terminals for receiving and transmitting the data and various control signals for communicating with the partner (data processing device).

In practice, a number of RAM packages are frequently combined to form a module and operated simultaneously in order to create a memory system with high storage capacity and high data throughput. In this arrangement, a common controller is used which has a correspondingly multiplied number of data terminals in order to communicate simultaneously and in parallel with the data terminals of all RAMs of the module. In the text which follows, it will be briefly explained how this is implemented in a conventional manner. For this purpose, FIG. 1 shows an example of the configuration of a conventional controller in connection with a number of RAM packages according to the prior art. The controller 100, shown diagrammatically and in fragmentary form in FIG. 1, has a plurality of m identical sections 110-i, the lower case letter “i” specifying the consecutive number 1 . . . m. In the text which follows, these sections will be called “transfer block” in each case. Each transfer block 110-i is responsible for exchanging data with an individually allocated RAM package RAM-i. Thus, the totality of the transfer blocks 110-1 . . . m forms the data interface of the controller for communicating with the arrangement of RAM packages. Each transfer block is connected to one side of an internal circuit arrangement 120 by means of an associated set of internal data and control lines inside the controller 100. This circuit arrangement is only shown in fragmentary form; its other side (not shown) has data and control terminals for communicating with a partner (e.g., data processing device, not shown), which is the source of the data to be written into the RAM packages and the sink for the data read out of the RAM packages.

The internal circuit arrangement 120 of the controller 100, also called “core” of the controller by many manufacturers, generates various control and command signals both for the transfer blocks 110-1 . . . m and for the RAM packages and arranges the correlation of the data streams and the accompanying control signals between the partner (data processing device) and the transfer blocks. Apart from a timing control function, it also has the function of organizing the distribution of the data and of various control signals to the various transfer blocks and for this reason is also briefly called “distributor circuit” here.

The m RAM packages RAM-1 . . . m are of the same type of construction. Each RAM package RAM-i has in each case a plurality of bidirectional data terminals for data DQ-i of word width “n”, a bidirectional strobe terminal for the associated strobe signal DS-i and a unidirectional terminal for receiving the associated masking signal DM-i. At high data rates, a double-pole strobe terminal is necessary or at least desirable in order to transmit the strobe signal DS also in complementary form so that the timing reference for the data sampling can be defined by the cross-over points of the complementary strobe signal edges. The DQ, DS and DM terminals of each RAM-i are connected to corresponding terminals of the associated transfer block 110-i via connecting lines.

The command and address signals C/A mentioned and an associated clock signal CLK for the RAM packages are generated by the internal distributor circuit 120 of the controller 100, the control lines emanating from there being branched in such a manner that all RAM packages RAM-1 . . . m receive the same C/A and CLK signals at their relevant terminals.

In order to operate m RAM packages in parallel with the possibility of data maskings, the controller 100 must have a total of m*n external data terminals, 2*m external strobe terminals and m external masking terminals alone for equipping the transfer blocks 110-1 . . . m on the side facing the RAM packages. Thus, a conventional controller for m=16 parallel RAMs of word width 4 (×4 RAMs) needs 16*(4+3)=112 external terminals for the transfer of data on the side facing the RAM packages and a corresponding number of connecting lines to the RAM packages. If data masking is dispensed with, the number of terminals is reduced to 16*(4+2)=96. It is possible to manage with fewer terminals at the same data throughput if n is doubled and m is halved: for m=8 parallel RAMs of word width n=8 (×8 RAMs), 8*(8+3)=88 terminals are needed with the option for data masking or 8*(8+2)=80 data terminals when dispensing with data masking.

In conventional memory controllers, the word width of the data terminals at each transfer block 110-i must be equal to the word width of data terminals at the individual RAM packages. Accordingly, memory module types which differ with respect to the word width of the RAMs contained therein require different controller types.

### SUMMARY OF THE INVENTION

It is the object of the invention to develop a memory controller with a number of parallel transfer blocks in such a manner that it allows at least one memory package to be connected, the word width of which is a multiple p≧2 of the word width n of the transfer blocks.

Accordingly, the invention is implemented in a memory controller which, for the exchange of data between a digital memory arrangement and a data processing device, includes a distributor circuit, to be connected to the data processing device, and a plurality m≧2 of parallel transfer blocks, each of which is constructed for transmitting data words which in each case consist of n parallel data bits and each of which contains the following: a first interface side which exhibits data terminals for transmitting and receiving data words which in each case consist of n parallel data bits, to and, respectively, from the memory arrangement; a second interface side which contains data terminals and strobe terminals in order to transfer the data words and a respective accompanying strobe signal which provides the timing reference for sampling the data words, between the transfer block and the distributor circuit; and internal data channels for transferring the data words between the data terminals of the first interface side and the data terminals of the second interface side. According to the invention, in at least one group of p≧2 transfer blocks, only one of the transfer blocks is configured as a master for transferring the strobe signals between the strobe terminals of the two interface sides of this transfer block, and all other transfer blocks of the group are in each case configured as a slave in that the strobe terminals provided for transmitting the strobe signal to the distributor circuit are connected to the relevant strobe terminals of the master.

The object set is also achieved by a memory controller in which each of the parallel transfer blocks contains the following: a write data channel which has an input for the write data words supplied by the distributor circuit and an output for transmitting these data words to the memory arrangement; a read data channel which has an input for the read data words received from the memory arrangement and an output for transmitting these data words to the distributor circuit; a write strobe channel with an input for receiving a write strobe signal which provides the timing reference for sampling the write data words; and a read data sampling device with a sampling input for sampling the read data words by means of a read strobe signal.

In this arrangement, according to the invention, each transfer block contains configuration means in order to set the transfer block optionally in a master configuration or in a slave configuration. In the master configuration, the input of the write strobe channel is set for receiving the write strobe signal supplied by the distributor circuit, the output of the write strobe channel is set for transmitting a write strobe signal to the memory arrangement, the sampling input of the read data sampling device is set for receiving a read strobe signal supplied by the memory arrangement, and a read strobe output path is set up for transmitting the read strobe signal to the distributor circuit. The slave configuration differs from the master configuration in that the sampling input of the read data sampling device is connected for receiving the read strobe signal which passes via the read strobe output path of a transfer block set in the master configuration.

An essential advantage of the invention consists in that the configuration of the controller can be established for connecting memory packages of a selected data word width without having to change the basic configuration of the individual transfer blocks. RAMs with a large (doubled) word width can in each case use the data terminals of two transfer blocks of the controller in parallel whereas only the strobe terminal of one of the two transfer blocks is used for the strobe signal. This also reduces the number of the terminals to be used in a controller according to the invention if half the number of RAMs with, in each case, twice the word width is connected.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows an example of the configuration of a conventional controller in connection with a number of RAM packages according to the prior art;

FIG. 2 shows the circuit diagram of a transfer block in a controller without data masking according to the prior art;

FIG. 3 shows the circuit diagram of a transfer block for a controller according to the invention without data masking;

FIG. 4 shows an example of the connection of a controller according to the invention without data masking, with a number of RAM packages, the word width of which is twice as large as the word width of the transfer blocks of the controller;

FIG. 5 shows the circuit diagram of a transfer block for a controller according to the invention with data masking; and

FIG. 6 shows an example of the connection of a controller according to the invention with data masking with a number of RAM packages, the word width of which is twice as large as the word width of the transfer blocks of the controller.

### DETAILED DESCRIPTION OF THE PREFERRED EMBODIMENT

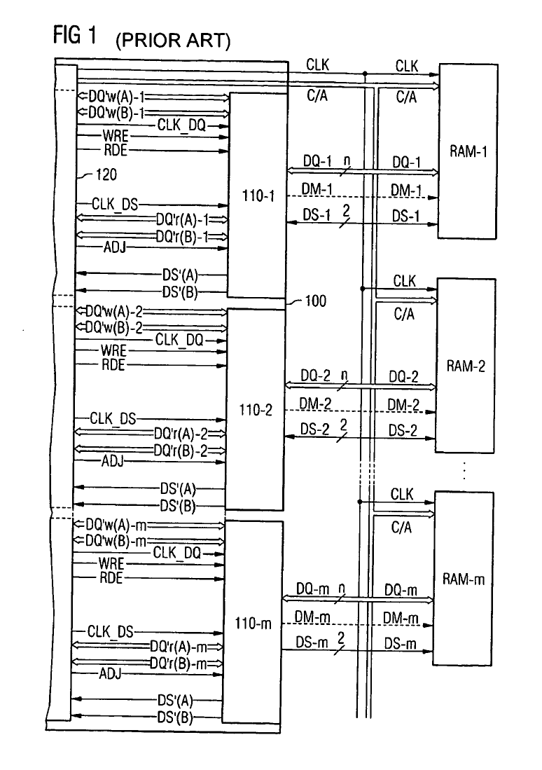

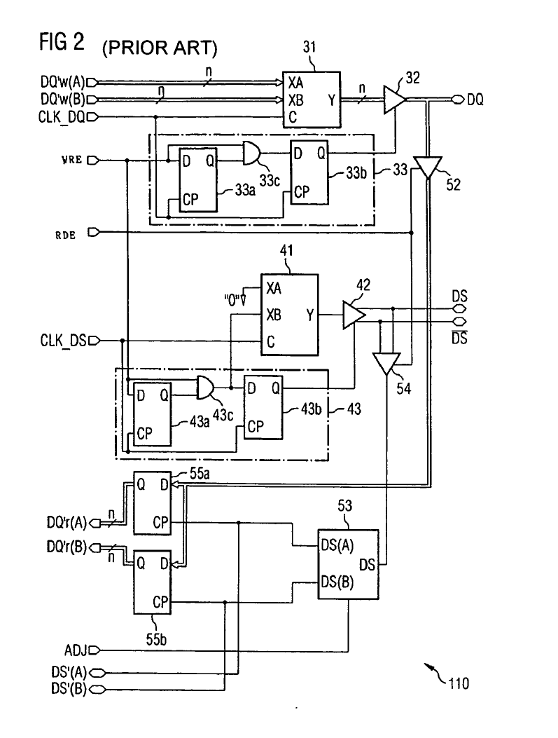

The transfer block 110 shown in FIG. 2 corresponds to each of the transfer blocks 110-1 . . . m of the conventional controller 100 according to FIG. 1, but without circuit parts and terminals for data masking. The transfer block 110 has on its right-hand edge a first interface side which contains the “external” terminals for communicating with an individually allocated RAM package. This is the bidirectional n-bit terminal DQ for transmitting the n-bit data words (write data) to be written into the RAM package at this package and for receiving the n-bit words (read data) read out of this package and the double-pole strobe terminal DS for transmitting and receiving the complementary phases of the strobe signal, accompanying the data, to, and respectively, from the RAM package. Communication with the internal distributor circuit 120 is effected by a second interface side, the terminals of which are shown on the left-hand edge in FIG. 2.

The transfer block 110 according to FIG. 2 is designed for operating a connected RAM package in so-called “DDR” mode (double data rate). In this mode, the data are sampled both at rising and at falling edges of a clock or strobe signal wave of frequency fc. In the text which follows, the period 1/fc of this frequency is designated by Σ.

Firstly, the write operation of the transfer block 110 according to FIG. 2 will be described, that is to say, the transfer of the write data from the distributor circuit 120 to the associated RAM package.

In a write operation of the transfer block 110, the internal distributor circuit 120 simultaneously sends two n-bit write data words DQ′w(A) and DQ′w(B) with each rising edge of a data clock CLK_DQ of frequency fc. Thus, the transfer block 110 receives the write data as parallel word pairs with “single data rate” (SDR) fc and converts them into a single-word sequence with double data rate 2fc in the write channel of the transfer block. For this purpose, an SDR/DDR converter 31 with two inputs XA and XB is used for receiving the parallel data words DQ′w(A) and DQ′w(B), a clock terminal C for receiving the data clock CLK_DQ and an output Y. The converter 31 consists of a circuit which transfers the two input signals, which are simultaneously injected with each clock cycle (with the rising edge of the clock wave) at XA and XB, successively in time at intervals of half a clock period (i.e. at interval τ/2) to the output Y. This can be done, for example, by latching the input signal pair at both inputs of a 2:1 multiplexer in the converter 31 (holding it until the next pair of signals is injected), and switching this multiplexer by means of the alternating half periods (alternating logic values “0” and “1”) of the clock wave.

The n-bit data words following one another at twice the data rate from output Y of the converter 31 are applied via a data transmit driver 32 to the DQ terminals, from where they are transmitted to the DQ terminals of the associated RAM package. The data transmit driver 32 is switched on depending on a write enable signal WRE which accompanies the sequence (“burst”) of the write data words DQ′w(A) and DQ′w(B) from the distributor circuit 120 and is only held at the active “1” level for the duration of this sequence. However, the data transmit driver 32 must only be switched on when the first data word of the sequence appears at the driver input, and it must be ended immediately after the last data word of the sequence has appeared at the driver input. Because of the SDR/DDR conversion in the converter 31, the DDR sequence at the driver input is delayed by one period τ of the data clock CLK_DQ with respect to the SDR sequence at the converter input. For this reason, the switch-on interval of the driver 32 must be correspondingly delayed by this measure τ.

This delay is effected by means of a delay logic 33 which, in the case shown, contains a cascade of two D-type flip flops (data flip flops) 33a and 33b, both of which are clocked by the rising edges of the signal CLK_DQ at their clock inputs CP, and the first one of which receives the write enable signal WRE at its D input. The Q output of this flip flop 33a thus goes to “1” as soon as the first “1” half wave of the data clock signal CLK_DQ appears after activation of the signal WRE, and remains at this level until the first “1” half wave of the data clock signal CLK_DQ appears after deactivation of the signal WRE. The Q output of the first D-type flip flop 33a is logically combined with the write enable signal WRE in an AND gate 33c, and the result of this logical combination is applied to the D input of the second D-type flip flop 33b, the Q output of which controls the transmitter amplifier 32. Thus, the transmitter driver 32 is only switched on with the beginning of the second “1” half wave of the data clock signal CLK_DQ after activation of the signal WRE and remains switched on until the first “1” half wave of the data clock signal CLK_DQ appears after deactivation of the signal WRE.

Together with the parallel data word pairs DQ′w(A) and DQ′w(B), the data clock signal CLK_DQ and the write enable signal WRE the transfer block 110 also receives a strobe clock signal CLK_DS which has the same frequency as CLK_DQ, but appears with such a phase that its rising edges in each case fall into the center between the bit boundaries of the parallel data word pairs. From this strobe clock signal CLK_DS, the write strobe signal, which is applied to the DS terminal and is transferred to the RAM package together with the DDR write data DQ and the edges of which should fall into the center between the bit boundaries of these DDR write data in order to be able to reliably sample these data in the RAM package, is derived in the write strobe channel of the transfer block. In the case shown, the write strobe signal is derived and transmitted similarly by means of a circuit arrangement which contains an SDR/DDR converter 41, a strobe transmit driver 42 and a delay logic 43 with two D-type flip flops 43a and 43b and an AND gate 43c. The circuits 41 and 43 are similar to the circuits 31 and 33 of the write data channel and operate in accordance with the same principle and are controlled by the write enable signal WRE. The only difference is that the XA input of the converter 41 is permanently held at the logic value “0” (by fixed connection to the “0” potential) and that its XB input is connected to the output of the AND gate 43a of the delay logic 43 and that the clock control of all elements is effected by the strobe clock signal CLK_DS. As can be easily seen, this leads to the output Y of the converter 41 periodically changing between “1” and “0” after the first “1” half wave of the signal CLK_DS after activation of the write enable signal WRE, and this in synchronism with CLK_DS. The strobe transmit driver 42 is only switched on with the beginning of the second “1” half wave of the strobe clock signal CLK_DS after activation of the signal WRE and remains switched on until the first “1” half wave of the strobe clock signal CLK_DS appears after deactivation of the signal WRE. The strobe transmit driver 42 transmits its output signal in symmetric or, respectively, complementary form, that is to say, non-inverted on a first line and inverted on a second line.

In read operation of the transfer block 110, that is to say, for transferring the read data from the RAM package to the internal distributor circuit 120, the write enable signal is deactivated (logic level “0”) so that the data transmit driver 32 and the strobe transmit driver are switched off. Instead, a read enable signal RDE supplied by the distributor circuit 120 is activated (logic level “1”) so that a data receive driver 52 connected to the bidirectional DQ terminals, and a strobe receive driver 54 connected to the bidirectional DS terminal are switched on. The strobe receive driver 54 has a symmetric input and asymmetric output in order to convert the read strobe signal with complementary symmetry supplied by the RAM into single-phase form. The RAM package supplies the read data words with twice the data rate and the accompanying read strobe signal to the associated terminals DQ and DS, respectively, of the transfer block 110.

In read mode, the phase relationship between the read data received in the DDR format and the accompanying read strobe signal is usually such that the rising and falling edges of the strobe signal appear in coincidence with the bit boundaries of the data DQ, and these edges are displaced into the center between the bit boundaries for sampling the read data in the transfer block, together with the reconversion (demultiplexing) of the read data from the DDR format into the SDR format. For this purpose, the read strobe signal coming from the strobe receive driver 54 is supplied to a phase control circuit 53 which generates two new versions of the read strobe signal: a first version DS′(A) for sampling the even-numbered data words in the DDR data sequence, and a second version DS′(B) for sampling the odd-numbered data words in the DDR data sequence. DS′(A) is delayed by a quarter period τ/4 of the clock frequency fc with respect to DS (i.e., half a period of twice the data rate), and DS′(B) is delayed by a three-quarter period 3τ/4 of the clock frequency fc with respect to DS (i.e., by one and a half periods of twice the data rate). The delays effected in the circuit 53 can usually be trimmed by means of an adjustment signal ADJ which can be applied by the distributor circuit 120 via an associated terminal.

The sequence of read data words DQ received in the DDR format via the data receive driver 52 is applied in the same phase in a read data channel to the data inputs of two D-type flip flops 55a and 55b which form a read data sampling device. The first D-type flip flop 55a is clocked by the rising edges of the signal DS′(A) so that its Q output supplies a read data word sequence DQ′r(A) which only contains the “even” read data words and is transferred to the distributor circuit 120 via an associated first read data line group. The second D-type flip flop 55b is clocked by the rising edges of the signal DS′(B) so that its Q output supplies a read data word sequence DQ′r(B) which only contains the “odd” read data words and is transferred to the distributor circuit 120 via an associated second read data line group. In the circuit 120, the two data word sequences DQ′r(A) and DQ′r(B) are clocked into associated receive registers and are controlled by the signals DS′(A) and DS′(B) which are transferred for this purpose to the circuit 120 via associated terminals.

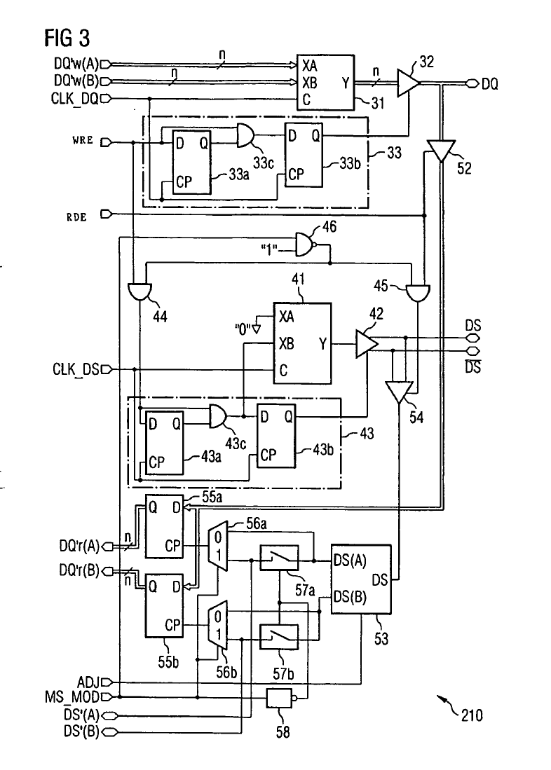

The embodiment of a transfer block according to the invention, shown in FIG. 3, which overall is designated by the reference number 210, is intended to enable a group of two (or more) transfer blocks to be used in parallel for communication with a single “widened” RAM package, the data word width of which is twice (or several times) as large as the data word width n of each transfer block. According to the invention, in such a use, only a bidirectional strobe signal connection should be sufficient for transmitting the strobe signal to and from the widened RAM package in order to minimize the number of connecting lines and thus also the number of external terminals.

The transfer block 210 according to the invention according to FIG. 3 differs from the conventional transfer block 110 according to FIG. 2 in that additional switching means are provided in order to optionally select the clock control for forwarding the received read data words to the distributor circuit 120 between two operating modes. In the first operating mode, called “master” mode in the text that follows, the said clock control is dependent on the read strobe signal DS that comes from the RAM package via the strobe receive driver 54 as has been described as prior art by means of the transfer block 110 according to FIG. 2. In the second operating mode, called “slave” mode in the text which follows, the said clock control should be effected in dependence on the read strobe signal which comes from the RAM package via the transfer block of the same group, configured in the master mode.

The said additional switching means for selecting between master and slave mode contain a switching device, inserted between the outputs of the strobe phase control device 53 and the clock inputs CP of the D-type flip flops 55a and 55b, consisting of two multiplexers 56a and 56b which are controlled by a master/slave mode signal MS_MOD, and two transmission gates 57a and 57b which are controlled by the complement of the master/slave mode signal MS_MOD via an inverter 58. The mode signal MS_MOD, which is applied via an associated terminal by the distributor circuit 120, is kept at the logic value “0” for the master mode. As a result, the strobe signal DS′(A) supplied by the phase control device 53 passes via the multiplexer 56a to the clock input of the D-type flip flop 55a and via the transmission gate 57a to the DS′(A) terminal, and the strobe signal DS′(B) supplied by the phase control device 53 passes via the multiplexer 56b to the clock input of the D-type flip flop 55b and via the transmission gate 57b to the DS′(B) terminal. Thus, the master mode results in the same configuration as in the conventional transfer block 110 according to FIG. 2.

For the slave mode, the mode signal MS_MOD is kept at “1”. As a result, the transmission gates 57a and 57b are tapped off, and the clock input of the D-type flip flop 55a is isolated from the phase control device 53 and, instead, connected to the DS′(A) terminal. In a similar manner, the clock input of the D-type flip flop 55b is isolated from the phase control device 53 and, instead, connected to the DS′(B) terminal.

In a preferred embodiment, further additional measures are taken in the transfer block 210 in order to deactivate the internal connections to and from the bidirectional DS terminal when the transfer block is operated in slave mode. For this purpose, an AND gate 44 is provided between the WRE terminal and the input of the AND gate 43c of the write strobe delay logic 43, which AND gate 44 only forwards the logic “1” of the active write enable signal if the transfer block is in master mode. Furthermore, an AND gate 45 is provided between the RDE terminal and the control input of the strobe receive driver 54 which AND gate 45 only forwards the logic “1” of the active read enable signal when the transfer block is in master mode. This is achieved by controlling the two AND gates 44 and 45 with the version of the mode signal MS_MOD inverted in an inverter 46. The inverter 46 is preferably formed by a NAND gate, the second input of which is permanently kept at the logic value “1”.

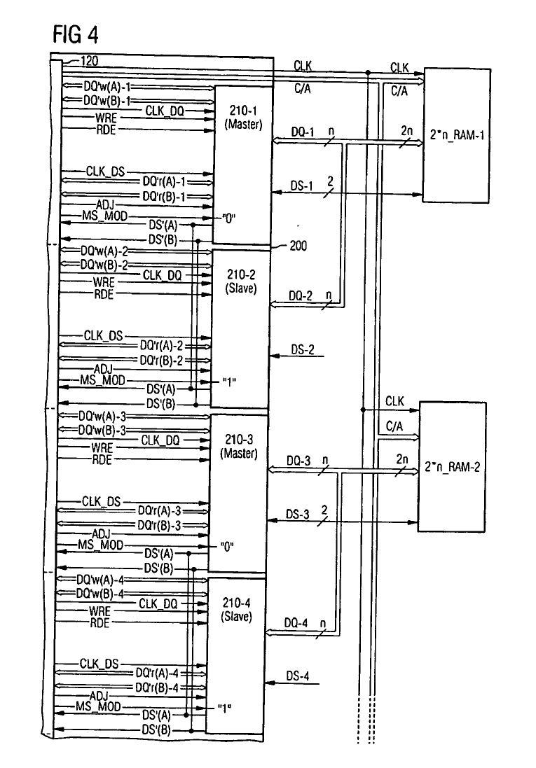

FIG. 4 shows the configuration and manner of connection of a controller 200 according to the invention which is equipped with transfer blocks 210 of the type shown in FIG. 3 in order to operate RAM packages, the word width of which is twice the word width n of the transfer blocks. Each of these packages which are in each case designated by 2*n_RAM in FIG. 4, is associated with a group of two adjacent transfer blocks 210 of the controller 200, one of which is configured as “master” by the logic value “0” at the MS_MODE terminal and the other one of which is configured as “slave” by the logic value “1” at the MS_MODE terminal. The DS′(A) and DS′(B) terminals of each slave (e.g., of block 210-2) are connected to the terminals of the same name of the master (e.g., of block 210-1) of the relevant group.

The n bidirectional data terminals (DQ terminals) of each master are connected to n first data terminals of the associated 2*n_RAM package, and the n bidirectional DQ terminals of the associated slave are connected to n second data terminals of this package. The strobe terminal of each 2*n_RAM package is connected to the bidirectional strobe terminal (DS terminal) of only the associated master.

A direct strobe signal connection between the 2*n_RAM and the slave can be omitted. The write strobe signal sent by the master is used in the 2*n_RAM for reliably sampling both the write data sent by the master and the write data sent by the slave. The read strobe signal directly received from the 2*n_RAM at the master is used in the master as timing reference for generating the clock control signals DS′(A) and DS′(B) by means of which the read data received at the master are forwarded to the internal distributor circuit 120. The same clock control signals also reach the slave via the above-mentioned master-slave connection of the DS′(A,B) terminals, where they are used for forwarding the read data received at the slave to the distributor circuit 120. The bidirectional DS terminal at the slave can thus remain unused and the number of connections between the controller and the RAM packages is correspondingly reduced.

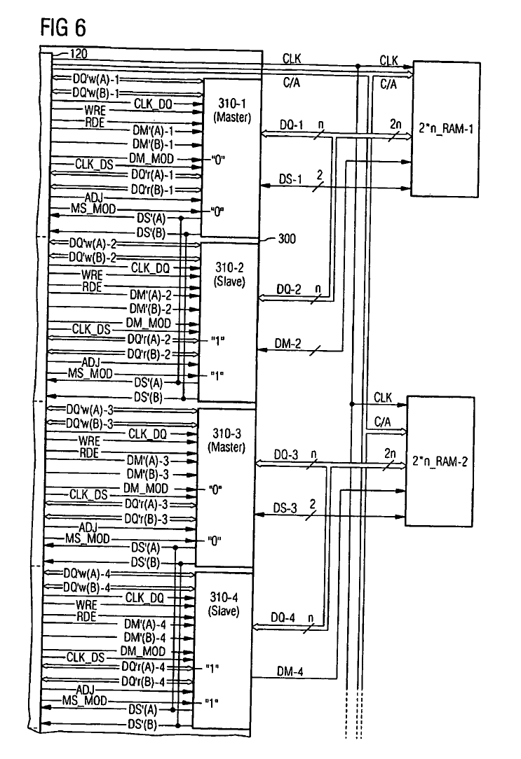

The signal connections between the DS′ terminals of the transfer blocks belonging to the same group are drawn outside the distributor circuit 120 in FIG. 4 (and also in FIG. 6, still to be described) for reasons of clarity of the drawing at the connecting lines. Naturally, these connections can also be located inside the distributor circuit 120.

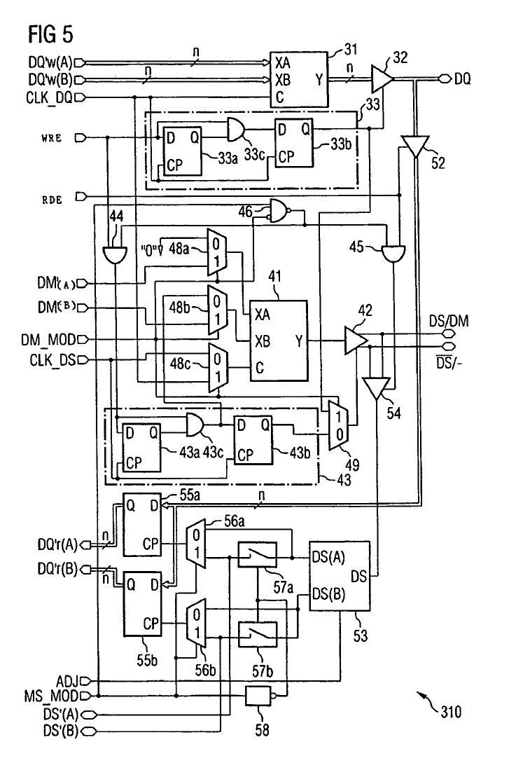

Similar to the embodiment according to FIG. 3, the embodiment of a transfer block according to the invention shown in FIG. 5, which overall is designated by the reference number 310, should enable a group of two (or more) transfer blocks to be used in parallel for communication with a single “widened” RAM package, the data word width of which is twice (or several times) as large as the data word width n of each transfer block. In addition, the transfer block 310 according to FIG. 5 enables data masking signals to be transmitted to the RAM package via a single connecting path between the relevant group of transfer blocks and the RAM package.

The transfer block 310 according to the invention according to FIG. 5 differs from the transfer block 210 according to FIG. 3, in that additional switching means are provided in order to rededicate the write strobe channel to circuits 41, 42 and 43 and the DS terminals which are unused in the slave mode, for the transmission of the data masking signals DM in the slave mode. For this purpose, each of the inputs XA, XB and C of the converter 41 contained in the write strobe channel is in each case preceded by a changeover switch in the form of a 2:1 multiplexer 48a, 48b and 48c, respectively, and the control input of the strobe transmit driver 42 is preceded by a changeover switch in the form of a 2:1 multiplexer 49. All of these multiplexers are controlled by a masking mode signal DM_MOD which is supplied by the distributor circuit 120 via an associated terminal and is also applied in inverted form to the second input of the NAND gate 46. The masking signals DM′(A) and DM′(B) for the even and odd write data words DQ′w(A) and DQ′w(B) are sent together and in synchronism with these data words from the distributor circuit 120 to associated input terminals of the transfer block 310 according to FIG. 5, that is to say, in synchronism with the data clock signal CLK_DQ.

When the mode signal DM_MOD is at “0”, the multiplexers 48a, 48b, 48c and 49 establish the same connections as exist in the transfer block 210 according to FIG. 3. In order to set the masking mode, the mode signal DM_MOD is set to “1” so that the NAND gate 46 supplies a “0”, as a result of which the multiplexers 48a, 48b, 48c and 49 are set in such a manner that the inputs XA and XB of the SDR/DDR converter 41 receive the masking signals DM′(A) and DM′(B), respectively, that the clock input C of the converter 41 receives the data clock signal CLK_DQ and that the control input of the strobe transmit driver 42 receives the same signal as the control input of the data transmit driver 32. The write strobe channel thus operates as a masking signal transfer channel; it converts the 1-bit masking signals DM′(A) and DM′(B), which accompany the write data words DQ′w(A) and DQ′w(B) from the distributor circuit 120, from the SDR format into the DDR format so that they appear at the DS terminal in exactly the same phase as the write data words, converted into the DDR format, at the bidirectional parallel DQ terminals.

Naturally, the masking mode described can and must only be set in a transfer block which is configured as slave because it is only then, that the write strobe channel is not used for strobe transmission. For this reason, it must be ensured that in the masking mode of a transfer block configured as slave, the write strobe channel can still respond to the write enable signal WRE. In the transfer block 310 according to FIG. 5, this is ensured by the fact that the second input of the NAND gate 46 receives the masking mode signal DM_MOD in inverted form so that, in the masking mode of the transfer block, this gate always supplies a “1” in order to condition the AND gate 44 for forwarding the write enable signal WRE to the write strobe channel.

The transfer block 310 according to FIG. 5 is universally applicable: with the logic value “0” in both of the master/slave mode signals MS_MOD and of the masking mode signal DM_MOD, it is configured like the transfer block 110 according to FIG. 2, that is to say, can be used as master in a controller without data masking. With MS_MOD=“0” and DM_MOD=“1”, the transfer block 310 can be used as master in a controller with data masking. With MS_MOD=“1” and DM_MOD=“1”, the transfer block 310 can be used as slave in a controller with data masking.

FIG. 6 shows the configuration and the method of connection of a controller 300 according to the invention which is equipped with transfer blocks 310 of the type shown in FIG. 5 in order to operate RAM packages, the word width of which is double the word width n of the transfer blocks, with the possibility of data masking. Each of these packages, which are in each case designated by 2*n_RAM in FIG. 6, is allocated to a group of two adjacent transfer blocks 310 of the controller 300, one of which is configured as “master” by the logic value “0” at the MS_MODE terminal and the other one of which is configured as “slave” by the logic value “1” at the MS_MODE terminal. This, and the method of connection for the data transmission and strobe transmission, corresponds to the arrangement according to FIG. 4 already described and, therefore, does not need to be explained again at this point.

The method of connection shown in FIG. 6 has the additional special feature that the slave used for transmitting the masking signal DM in each group is correspondingly conditioned by a “1” at its DM_MOD terminal (the master of each group receives a “0” at this terminal), and that the strobe terminal of the said slave which is unused in the case of FIG. 4, is now used for transmitting the masking signal DM to the 2*n_RAM allocated to the relevant master/slave group. At the 2*n_RAM, the bit of this signal is used for masking all bits of the 2n-bit data word arriving at the same time, if desired. The logic value of the masking signal bit specifies whether the relevant data word is to be masked or not.

The connection for transmitting the masking signal DM from a slave to the 2*n_RAM only needs to be single-cored and is unidirectional. Thus, the complementation can be switched off at the transmit driver 42 in each transfer block 310 operated as slave. This means that the relevant driver can be configured from symmetric output to asymmetric output in response to the masking mode signal DM_MOD.

The circuit arrangements described above by means of FIG. 3 to FIG. 6 are only examples for implementing and utilizing the invention. Naturally, there is a number of further forms of application, embodiments, modifications and alternatives within the concept of the invention. Some of these will be briefly indicated in the text which follows:

The controllers according to the invention are preferably in each case formed as an integrated package on a semiconductor chip. In this arrangement, the reduction in external terminals, which can be achieved by means of the invention, is of particular advantage.

In the case where in each case two transfer blocks are grouped, one of which is configured as master and the other of which is configured as slave, as shown in the above examples, the connections drawn from master to slave for the purpose of strobe coupling can be kept short by ensuring that the read data sampling device and the channels leading to this device extend as closely as possible to the edges of the blocks facing one another. For this purpose, it may be advantageous to design the layout of master and slave in a mirror image of one another. Short master-strobe coupling connections reduce the expenditure for any delay equalization which may be necessary between the operation of the two blocks.

Instead of grouping in each case two transfer blocks, one of which is configured as master and the other of which is configured as slave, groups with in each case more than two transfer blocks can also be organized, one of which is configured as master and all others are configured as slaves. Thus, a group of p transfer blocks, each of which has a word width n, can be used for operating a RAM package of word width p*n, requiring only a single strobe signal connection. If the possibility for data masking is to be created, only one of the slaves in the group needs to be configured for data masking.

The transfer blocks and the group division can be configured by the manufacturer of the controller by hardwiring or fixed design. There are various possibilities for this:

A first possibility is of using a conventional circuit, e.g., according to FIG. 2, for each master transfer block and to provide in each case a circuit for the slaves which is permanently configured for the slave mode and, if desired, also for the masking mode without needing corresponding mode signals. Although this reduces the number of necessary internal terminals and connections on the side facing the internal distributor circuit, it is then at the cost of flexibility of the manufactured controller. However, the advantage remains that a set of only three different transfer block layouts is sufficient for assembling controllers for an arbitrary number of RAMs of arbitrary word width with or without data masking.

A second possibility is to use in each case the same basic circuit for the master and for the slaves, which, however, can be configured by means of mode signals as described by means of the above examples, e.g. a circuit according to FIG. 3 (if no data masking is desired) or according to FIG. 5 (if data masking is desired). Such a “universal” controller can then be subsequently configured, desired in each case, i.e. adapted to the word width of the RAMs to be controlled, namely by creating corresponding signal connections at the mode terminals in the blocks and between the blocks as is shown in FIG. 4 and FIG. 6. These signal connections can be produced by the manufacturer at a later stage in the manufacturing process so that customers' wishes can be fulfilled within a short time. However, the said signal connections can also be produced by the customer himself.

A “universal” controller can even be configured in operation, more precisely during the initialization phase of operation. For this purpose, a higher level entity such as, e.g., the BIOS of a PC, can specify the data word width of the RAM packages of the memory module used, and during the initialization, can program a mode register in the distributor circuit of the controller in such a manner that the appropriate configuring control signals for the transfer blocks of the controller and, respectively, the configuring signal connections between the transfer blocks are set. In a “universal” controller which can be configured in this manner, the signal connections can be set by switching elements controllable by the mode register on built-in connecting lines inside the distributor circuit 120.

If desired, a “universal” version of the controller can even be used in order to operate a number of RAMs in a conventional manner, which have the same word width n as the transfer blocks as is shown in FIG. 1. The adaptation necessary for this can be effected, e.g., by permanently setting of all mode signals at all transfer blocks to “0” and omitting the signal connections between the blocks. However, this makes it necessary to dispense with the possibility of data masking because in this arrangement there is no slave and thus also no unoccupied write strobe channel which could be rededicated for the transmission of the masking signals.

The invention is particularly suitable in connection with RAM packages which are constructed as dynamic RAMs (DRAMS), preferably as “synchronous” DRAMs (SDRAMS) as has been assumed in the exemplary embodiments described. However, the use in combination with other RAM types, (e.g., static RAMs), is also within the scope of the invention.

The invention is not restricted to controllers for double the data rate (DDR) but can also be applied with the same advantages to controllers which control RAMs with a single data rate (SDR) or with quadruple or even higher data rate. In the case of the single data rate, the configuration of data and strobe channels inside the transfer blocks is much simpler than as shown in the figures because there is no SDR/DDR multiplexing of the write data in the write channels or DDR/SDR demultiplexing of the read data. A more detailed description of this simplified circuit technique can be omitted since a person skilled in the art will be able to easily transfer the technology described above in connection with complicated signal channels to signals channels of a simpler configuration.

In the examples shown in FIG. 4 and FIG. 6, the internal distributor circuit 120 is also divided into blocks corresponding to the transfer blocks of the controller. However, the internal distributor circuit can also be organized in a different way, e.g., in such a manner that for each group of transfer blocks which are jointly allocated to a single p*n RAM, one block of this circuit is in each case provided for a data word width 2p*n (in the case of a controller with SDR/DDR conversion), or for a word width p*n (in the case of an SDR controller). For such an organization of the internal distributor circuit, the internal connecting lines for the control signals (strobe, clock and other control signals) between the distributor circuit and the transfer blocks are reduced because in this arrangement, the same control signals are applied to all transfer blocks of the same group. The internal distributor circuit can even be organized in blocks (or as a single block) for an even greater data word width, each of these blocks being allocated to a group of a plurality of entire transfer block groups. For such an organization, the internal connecting lines are reduced even further because in this arrangement, the same control signals are applied to all transfer blocks of the same group of transfer block groups.

Finally, it should also be mentioned that the transmission of the data and strobe signals between the transfer blocks and the distributor circuit inside the controller can also take place via bidirectional channels. In this arrangement, the number of relevant terminals and connecting lines is reduced by one half. Naturally, a switch-over device (e.g., transmit and receive drivers which can be selectively switched on) must be provided for each terminal in this case in order to switch the terminals between the internal write and read channels.

While the foregoing is directed to embodiments of the present invention, other and further embodiments of the invention may be devised without departing from the basic scope thereof, and the scope thereof is determined by the claims that follow.

What is claimed is:

1. A memory controller for controlling an exchange of data between a digital memory arrangement and a data processing device, comprising:
a distributor circuit for connecting to the data processing device; and
a plurality (m≧2) of parallel transfer blocks, each configured to transmit data words, each data word having n parallel data bits, each transfer block comprising:
a first interface for communicating with the memory arrangement; and
a second interface for communicating with the distributor circuit, wherein each interface includes a plurality of data terminals for transferring the data words and one or more strobe terminals for transferring a respective accompanying strobe signal which provides a timing reference for sampling the data words;
wherein, in at least one group of p≧2 transfer blocks, only one of the transfer blocks in the respective at least one group is configured as a master transfer block for transferring the strobe signals between the memory arrangement and the one or more strobe terminals on the first interface of the master transfer block, and
wherein all other transfer blocks of the respective at least one group are configured as slave transfer blocks each having its respective strobe terminals on the second interface provided for transmitting the strobe signal to the distributor circuit connected to respective strobe terminals on the second interface of the master transfer block.

2. The memory controller of claim 1, wherein at least one slave transfer block of each group includes a masking signal channel for transferring a data masking signal from a masking signal receive terminal on the second interface side to a masking signal transmit terminal on the first interface side.

3. The memory controller of claim 1, wherein each group of p≧2 transfer blocks is connected to a respective memory package comprising:
a plurality of data terminals for receiving and transmitting wide data words having p*n parallel bits, wherein the plurality of data terminals are arranged into groups of n data terminals, each group of n data terminals of the memory package is connected to a first interface side of a corresponding transfer block of the group; and
one or more strobe terminals connected to respective one or more strobe terminals on the first interface of the master transfer block.

4. The memory controller of claim 3, wherein at least one slave transfer block of each group includes a masking signal channel for transferring a data masking signal from a masking signal receive terminal on the second interface side to a masking signal transmit terminal on the first interface side, and wherein the memory package includes a masking terminal connected to the masking signal transmit terminal on the at least one slave transfer block transmitting the data masking signal of the group.

5. The memory circuit of claim 4, wherein, in the slave transfer block configured to transfer the data masking signal, one of the strobe terminals on the first interface is configured as the masking signal transmit terminal.

6. The memory controller of claim 1, wherein each transfer block includes:
a mode selection signal terminal for receiving a mode selection signal; and
circuitry for selectively configuring the respective transfer block as one of a master transfer block and a slave transfer block depending on the received mode selection signal.

7. A memory controller for controlling an exchange of data between a digital memory arrangement and a data processing device, comprising:
a distributor circuit for connecting to the data processing device; and
a plurality m≧2 of parallel transfer blocks for transmitting data words having n parallel data bits, each transfer block comprising:
a write data channel having an input for receiving write data words supplied by the distributor circuit and an output for transmitting the received write data words to the memory arrangement;
a read data channel having an input for receiving read data words from the memory arrangement and an output for transmitting the received read data words to the distributor circuit;
a write strobe channel having an input for receiving a write strobe signal which provides a timing reference for sampling the write data words; and
a read data sampling device having a sampling input for sampling the read data words utilizing a read strobe signal;
wherein each transfer block includes first configuration means for selectively configuring the transfer block in one of a master configuration and a slave configuration, and wherein
in the master configuration, the input of the write strobe channel is set for receiving the write strobe signal supplied by the distributor circuit, the output of the write strobe channel is set for transmitting a write strobe signal to the memory arrangement, the sampling input of the read data sampling device is set for receiving a read strobe signal supplied by the memory arrangement, and a read strobe output path is set up for transmitting the read strobe signal to the distributor circuit, and
in a slave configuration, the sampling input of the read data sampling device is connected for receiving the read strobe signal via the read strobe output path of an associated transfer block set in the master configuration.

8. The memory controller of claim 7, wherein the first configuration means comprises a first switch-over device having a switching state which is set by a logic value of a first mode signal.

9. The memory controller of claim 7, wherein the plurality of transfer blocks are arranged into groups, each group having p≧2 transfer blocks, and wherein, in at least one group of transfer blocks, only one of the transfer blocks is configured as master and all other transfer blocks of the group are configured as slave.

10. The memory controller of claim 9, wherein each group of transfer blocks is connected to a respective memory package comprising:
a plurality of data terminals for receiving and transmitting wide data words having p*n parallel bits, the data terminals being connected for receiving and transmitting n parallel bits of the wide data words from and to, respectively, each transfer block of the group; and
a strobe terminal for receiving the write strobe signal from the output of the write strobe channel of the transfer block configured as master and transmitting the read strobe signal to the input of the read strobe channel of the transfer block configured as master.

11. The memory controller of claim 7, wherein each transfer block includes second configuration means for selectively configuring the transfer block in one of a first slave configuration and a second slave configuration, wherein
in the first slave configuration, the write strobe channel is disconnected from the memory arrangement, and
in the second slave configuration, the input of the write strobe channel is set for receiving a data masking signal accompanying the write data words from the distributor circuit, and the output of the write strobe channel is set for transmitting the data masking signal to the memory arrangement.

12. The memory controller of claim 11, wherein the second configuration means comprises a second switch-over device having a switching state which is set by a logic value of a second mode signal.

13. The memory controller of claim 11, wherein the plurality of transfer blocks are arranged into groups, each group having p≧2 transfer blocks, and wherein, within each group of p≧2 transfer blocks, only one of the transfer blocks is set in the second slave configuration and all other transfer blocks configured as slave are set in the first slave configuration.

14. The memory controller of claim 13, wherein each group of transfer blocks is connected to a respective memory package comprising:
a plurality of data terminals for receiving and transmitting wide data words having p*n parallel bits, the data terminals being connected for receiving and transmitting n parallel bits of the wide data words from and to, respectively, each transfer block of the group;
a strobe terminal for receiving the write strobe signal from the output of the write strobe channel of the transfer block configured as master and for transmitting the read strobe signal to the input of the read strobe channel of the transfer block configured as master; and
a masking terminal for receiving the data masking signal from the transfer block configured in the second slave configuration.

15. A memory system, comprising:
a memory arrangement comprising a plurality of memory modules, each memory module having a plurality of data terminals for receiving and transmitting wide data words having p*n parallel bits and a bidirectional strobe terminal for transferring one or more strobe signals; and
a memory controller comprising a distributor circuit for connecting the memory system to other components which access the memory system and a plurality of parallel transfer blocks arranged in groups of p transfer blocks, each group of transfer blocks connected to a respective memory module, each transfer block configured to transmit data words, each data word having n parallel data bits, each group of transfer blocks comprising:
a first transfer block selectively configured as a master transfer block based on a first mode signal, wherein the master transfer block is configured to communicate the one or more strobe signals with the respectively connected memory module;
one or more remaining transfer blocks selectively configured as one or more slave transfer blocks based on the first mode signal, wherein the slave transfer block is configured to provide a read strobe signal to the distributor circuit by tapping off a read strobe signal output from the master transfer block.

16. The memory system of claim 15, wherein each memory module includes a masking terminal for receiving a data masking signal, and wherein one slave transfer block of each group includes a masking signal channel for transferring the data masking signal from the distributor circuit to the respectively connected memory module.

17. The memory system of claim 16, wherein each transfer block includes a first switch-over device for selecting between configurations as the master transfer block and the slave transfer block based on a logic value of the first mode signal.

18. The system of claim 17, wherein each transfer block further includes a second switch-over device for selecting between a first slave configuration and a second slave configuration based on a logic value of a second mode signal, wherein in the first slave configuration, a write strobe channel of the respective transfer block is disabled, and in the second slave configuration, the write strobe channel is configured to transfer the data masking signal to the respectively connect memory module.

19. The system of claim 18, wherein each group includes only one master transfer block.

20. The system of claim 19, wherein each group includes at most one transfer block configured as the slave transfer block transferring the data masking signal.
